(19) United States
(12) Patent Application Publication
(10) Pub. No.: US 2017/0004490 A1
(43) Pub. Date: Jan. 5, 2017

(54) Systems and Methods for Managing Data Definitions Within Payment Applications

(71) Applicant: MASTERCARD INTERNATIONAL INCORPORATED, Purchase, NY (US)

(72) Inventors: Mary Marsh, Ballwin, MO (US); Sai Chaganti, Ballwin, MO (US)

(21) Appl. No.: 14/790,295

(22) Filed: Jul. 2, 2015

(51) Int. Cl. G06Q 20/38; G06F 17/30

(52) U.S. Cl. CPC G06Q 20/38; G06F 17/30076

(57) ABSTRACT

Systems and methods for use in managing data definitions within applications, including payment transaction applications, are disclosed. One example method includes identifying an application to be tested, where the application includes a pre-production code-segment and at least one data definition; comparing the at least one data definition of the application to a library of standard data definitions; and generating a report, where the report includes a flag when at least one discrepancy is identified by the computing device between the at least one data definition in the application and the standard data definitions.

### FIELD

The present disclosure generally relates to systems and methods for use in managing data definitions within applications such as, for example, payment transaction applications, and the like.

### BACKGROUND

This section provides background information related to the present disclosure which is not necessarily prior art.

A variety of data transfers occur within a payment network to permit transactions for the purchase of products and services. Applications involved in the handling of such transactions typically store transaction data in a variety of different locations in one or more forms, whereby the transaction data is appended to mass storage of data. In order for the data to be properly incorporated into the mass storage of data, forms of the transaction data delivered from the applications must be consistent with a predefined standard applied in connection with the mass storage.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in managing data definitions within payment applications;

FIG. 2 is a block diagram of a computing device that may be used in the exemplary system of FIG. 1; and

FIG. 3 is an exemplary method for use in managing data definitions in applications (e.g., pre-production applications, etc.).

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

As applications are developed, different programs and/or computer code segments, etc. (broadly, applications) are developed to generate and/or compile data related to particular operations (e.g., payment transactions, etc.) associated with the applications. The form in which the data is generated is defined by the applications, i.e., via data definitions. For example, data definitions may define data structures (e.g., tables, etc.), in which different data related to payment transactions, or other operations, is arranged, for example, into columns and rows. Further, the data structures may have other considerations such as, for example, nomenclature of columns, table names, class words for the columns of the tables (and maintaining such class words for the columns), table content, key validations, index validations, etc. As described herein, when the data structure is defined by an application, the data structure will be validated against standard definitions (so that, subsequently, it can be consistently processed as desired, for example, in connection with other data structures, etc.) and, if not in compliance, a report will be generated with all the violations so that the data structure can be fixed, updated, etc. before proceeding further in the development of the corresponding application and/or production release of the application.

The systems and methods herein provide for managing data definitions defined by applications, as the applications are developed, i.e., in pre-production applications. By testing the data structures of the pre-production applications, as the applications are developed incrementally (broadly, regularly, or occasionally), the data definitions of the applications may be altered and/or adjusted, during the development process, to conform to standard data definitions. In this manner, the development process results in production applications in which the data definitions therein are consistent with the standard data definitions. As such, the systems and methods herein can help reduce the potential of applications to have errant data definitions, whereby the applications must either be reworked, or implemented with the errant data definitions.

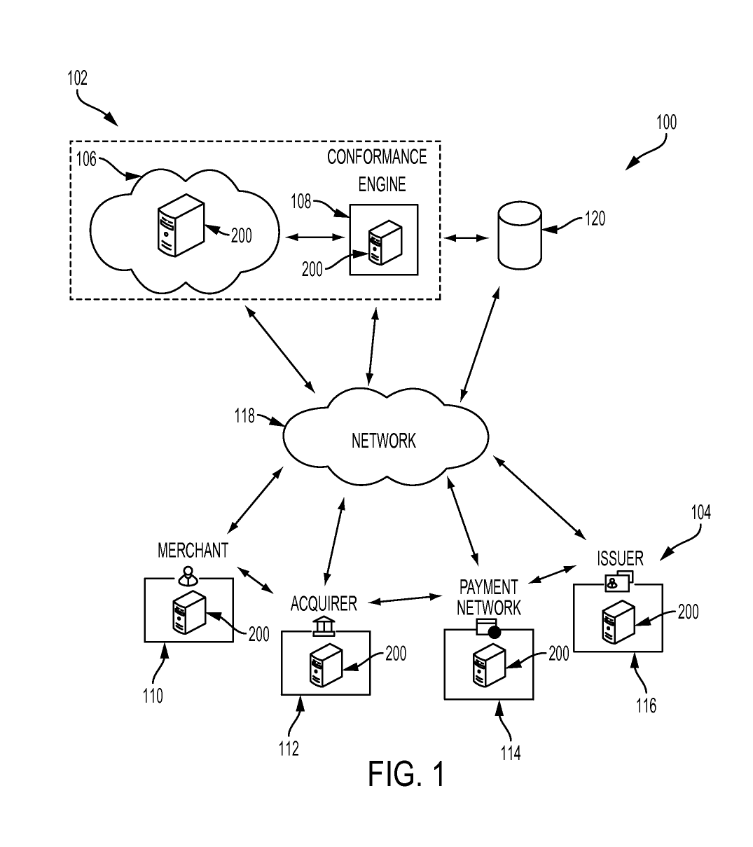

FIG. 1 illustrates an exemplary system 100, in which the one or more aspects of the present disclosure may be implemented. Although, in the described embodiment, components/entities of the system 100 are presented in one arrangement, other embodiments may include the same or different components/entities arranged otherwise.

The system 100 generally includes a development part 102 and an implementation part 104, in which various applications (e.g., payment transaction applications, etc.) are implemented.

The development part 102 of the system 100 includes a development environment 106, in which applications, including computer code segments, modules, etc., can be developed (e.g., pre-production applications, etc.). The development environment 106, in general, provides an environment in which one or more applications may be developed based on one or more existing application components (or modules), or as original components (or modules). The development environment 106 permits stand-in data, and/or data structures, to be setup or available, so that the applications can link to the data, or the data structures, whereby particular functions or processes in the applications may be executed (during development) with the data, or data structures, mimicking the data, or data structures, as present in the post-production or deployed (or live) environment. In various aspects, some application components (or modules) will be available to some developers but not others, depending on need, authorization, application type, etc.

In various embodiments, the development environment 106 provides management of coding, revision control, centralized development (e.g., cloud development, etc.), and ease of collaboration among multiple users. Generally, when an application is to be developed, a project is created in the development environment 106, through which one or more users can participate in developing the application. While one development environment 106 is shown in the system 100 of FIG. 1, it should be appreciated that more than one such environment may be implemented in other embodiments. After development, the applications are moved out of the development environment 106, i.e., post production, and delivered to one or more intended users.

As shown in FIG. 1, the development part 102 also includes a conformance engine 108, which (as indicated by the broken lines) is separate from, yet coupled to the development environment 106, in this embodiment. It should be appreciated that the conformance engine 108 may be incorporated into the development environment 106 in other embodiments.

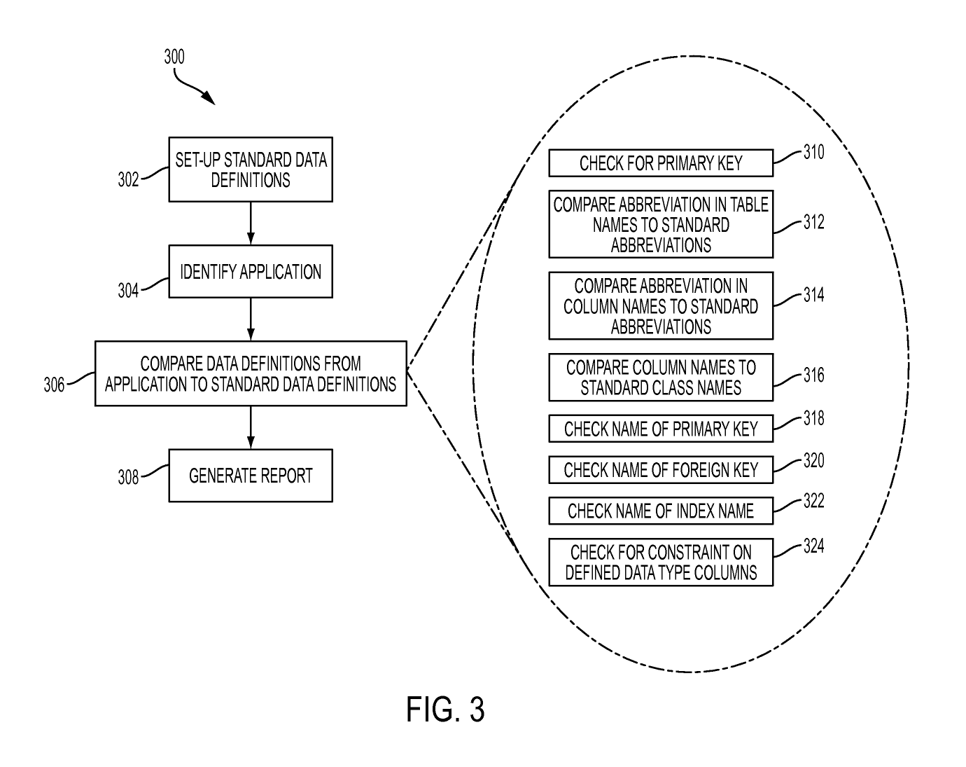

The conformance engine 108, as described more with reference to FIG. 3 and method 300, below, operates to evaluate data definitions included in pre-production applications developed in the development environment 106. In particular, once invoked by a user, or automatically, the conformance engine 108 compares the data definitions within an application, or parts thereof, to one or more standard data definitions (e.g., from a library of standard data definitions such as accumulated and/or maintained in database 120, etc.). The standard data definitions may be generic, in some embodiments, or specific (or customized) to a group of developers, or to an application, or type of application, as needed or appropriate. In various embodiment, the standard data definitions may be more broadly applied to developers within a division, or a company, or even an industry. The limit, or group(s), to which the standard data definitions apply is generally consistent to the limit, or group(s), or applications which may access the particular data (or data structures), prost-production. For example, if developers are involved in applications related to a transaction database, those developers and the to-be-developed applications would be limited to standard data definitions for that financial transaction database. Yet other developers whose applications will not access that financial transaction database may have different (and/or partially overlapping) standard data definitions available to them. Often, standard data definitions will be uniform to the applications, based on overlap between developers and/or data structures, or data. In the exemplary embodiment herein, the standard data definitions are applied to each application, which accesses or acts on data associated with one or more payment networks, for example. The conformance engine 108 then generates a report, in which discrepancies, if any, between the data definitions within the application and the standard data definitions are indicated.

With continued reference to FIG. 1, the implementation part 104 of the system 100 provides means through which applications, developed via the development part 102, i.e., post-production applications, can be implemented. Generally, the implementation of the applications provides for execution of the applications, whereby data is compiled by the applications, as defined by the data definitions included therein. The applications link to or generate the data, or the data structures, in the live environment (which were mimicked in the development environment 106). In FIG. 1, the exemplary implementation part 104 generally includes a merchant 110, an acquirer 112, a payment network 114, and an issuer 116, through which one or more payment account transactions may be processed.

In the illustrated system 100, the merchant 110, the acquirer 112, the payment network 114, and the issuer 116 of the implementation part 104 are coupled together via a network 118. In addition, the development environment 106 and the conformance engine 108 of the development part 102 are each coupled to the network 118. The network 118 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof.

Generally in the implementation part 104 of the system 100, when a consumer desires to purchase products (e.g., goods, services, etc.) from the merchant 110, the consumer presents payment account information to the merchant 110 in connection with the transaction. The merchant 110, the acquirer 112, the payment network 114, and the issuer 116 then cooperate, in response to the consumer, to complete the transaction using the consumer's payment account. As part of the payment transaction, the merchant 110 reads the payment account information from the consumer and communicates, via the network 118, an authorization request to the payment network 114, via the acquirer 112 (associated with the merchant 110), to process the transaction (e.g., using the MasterCard® interchange, etc.). The authorization request includes various details of the transaction (e.g., transaction data, etc.) to help facilitate processing the authorization request. The payment network 114, in turn, communicates the authorization request to the issuer 116 (associated with the consumer's payment account). The issuer 116 then provides an authorization response (e.g., authorizing or declining the request) to the payment network 114, which is provided back through the acquirer 112 to the merchant 110. The transaction with the consumer is then completed, or not, by the merchant 110, depending on the authorization response.

For the above transaction, transaction data is generated as part of the interactions among the merchant 110, the acquirer 112, the payment network 114, and the issuer 116. The transaction data may be used, for example, to clear and settle the transaction, provide for accrual of reward points to the consumer, at point of sale (POS) terminals, etc. In addition, the transaction data may include, without limitation, a payment account number (PAN) for the consumer's payment account involved in the transaction, a payment amount for the products involved in the transaction, identifiers for the products involved in the transaction, descriptions of the products involved in the transaction, a listing of products involved in the transaction, a merchant name for the merchant 110 involved in the transaction, a merchant identification number (MID) for the merchant 110, a merchant category code (MCC) assigned to the merchant 110 (e.g., by the payment network 114 or by another payment network, based on a type of product and/or service normally provided by the merchant 110, etc.), a date and/or time of the transaction, a location of the transaction, etc.

The transaction data is stored in one or more different components of the system 100, and transferred therebetween. In particular in the above transaction, applications, in place at the merchant 110, acquirer 112, payment network 114, and issuer 116 (and potentially others), capture and compile the transaction data related to the transactions. The transaction data may then be stored in memory associated with one or more of the different components of the system 100. In connection with storing and/or transferring the transaction data, the transaction data is often subject to automated processes and/or incorporation with other transaction data, and/or other data. It is therefore preferred to provide the transaction data according to one or more standard data definitions, whereby proper integration and/or recognition of the transaction data is made more efficient during such storage or transfer.

It should be appreciated that each of the components/entities illustrated in the system 100 of FIG. 1 includes (or is implemented in) one or more computing devices, such as a single computing device or multiple computing devices located together, or distributed across a geographic region. For example, the development environment 106 is implemented in computing device 200, which may provide the development environment 106 to a single user, or multiple users over a network (e.g., via a cloud development platform, etc.), such as network 118 or another network. In addition, each of the merchant 110, the acquirer 112, the payment network 114, and the issuer 116 are implemented in computing devices 200. The computing devices in the system 100 may include, for example, one or more servers, workstations, personal computers, laptops, tablets, PDAs, point of sale (POS) terminals, smartphones, etc.

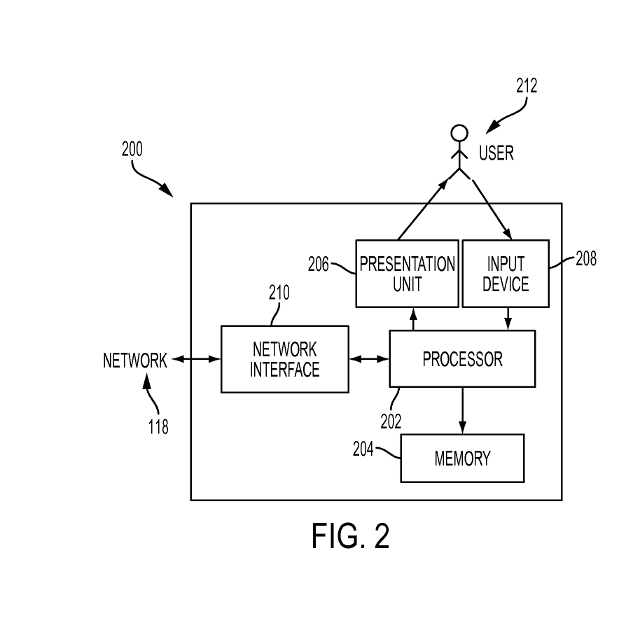

For illustration, the system 100 is described below with reference to an exemplary computing device 200, as illustrated in FIG. 2. Generally, the components/entities illustrated in FIG. 1 are embodied in one or more computing devices, such as the computing device 200, etc. The system 100, and the components/entities therein, however, should not be considered to be limited to the computing device 200, as different computing devices, and/or arrangements of computing devices may be used in other embodiments.

As shown in FIG. 2, the exemplary computing device 200 generally includes a processor 202, and a memory 204 coupled to the processor 202. The processor 202 may include, without limitation, a central processing unit (CPU), a microprocessor, a microcontroller, a programmable gate array, an application-specific integrated circuit (ASIC), a logic device, or the like. The processor 202 may be a single core, a multi-core processor, and/or multiple processors distributed within the computing device 200. The memory 204 is a computer readable media, which includes, without limitation, random access memory (RAM), a solid state disk, a hard disk, compact disc read only memory (CD-ROM), erasable programmable read only memory (EPROM), tape, flash drive, and/or any other type of volatile or nonvolatile physical or tangible computer-readable media. Memory 204 may be configured to store, without limitation, transaction data, code relating to applications, various data definitions (e.g., one or more libraries of data definitions, etc.), and/or other types of data suitable for use as described herein.

In the exemplary embodiment, computing device 200 also includes a display device 206 that is coupled to the processor 202. Display device 206 outputs to a user 212 by, for example, displaying and/or otherwise outputting information related to the performance of system 100 and/or method 300. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., graphical user interfaces (GUI), webpages, etc.) may be displayed at computing device 200. The computing device 200 also includes an input device 208 that receives input from the user 212. The input device 208 is coupled to the processor 202 and may include, for example, a keyboard, a pointing device, a mouse, a stylus, a touch sensitive panel (e.g., a touch pad or a touch screen, etc.), card reader, swipe reader, touchscreen, and/or an audio input device.

The computing device 200 further includes a network interface 210 coupled to the processor 202, which permits communication with one or more networks. The network interface 210 may include, without limitation, a wired network adapter, a wireless network adapter, a mobile telecommunications adapter, or other device capable of communicating to one or more different networks.

The computing device 200, as used herein, performs one or more functions, which may be described in computer executable instructions stored on memory 204 (e.g., a computer readable storage media, etc.), and executable by one or more processors 202. The computer readable storage media is a non-transitory computer readable media. By way of example, and without limitation, such computer readable storage media can include RAM, Read-only memory (ROM), Electrically Erasable Programmable Read-Only Memory (EEPROM), CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

Referring again to FIG. 1, in order for the conformance engine 108 of the system 100 to operate on an application (or target application, etc.) developed in the development environment 106 (e.g., prior to using the conformance engine 108, etc.), a user initially identifies the application to be evaluated (which may include an entire application, or a code segment thereof) from the development environment 106.

Next, the conformance engine 108 identifies each data definition (likely multiple such definitions) defined in the application and compares it to various standard data definitions accessible in library database 120. In various embodiments, the library database 120 is generated by one or more entities associated with the data to be compiled from the applications. In FIG. 1, for example, the payment network 110 may prescribe the standard data definitions, as stored in the library database 120, whereby data transferred within or among the entities associated with payment transactions (e.g., the above example payment transaction, etc.) is standardized. Others in FIG. 1, or other entities more generally, may also (or alternatively) be involved in providing the library database 120, or parts of the standard data definition included therein. For example another entity (not shown in FIG. 1, for example) may be involved in compiling the library of standard definitions where data, from the application, is expected to be used and integrated with data associated with that other entity. Examples of the particular standard data definitions are described below.

Also as part of operating on the application, the conformance engine 108 (or a user thereof) identifies a last date of invocation for the conformance engine 108 (if any) of the application so that only newly created data definitions in the application are evaluated. The conformance engine 108 may further identify standard data definitions (e.g., a subset based on the type of application, etc.). For example, when an application is related to clearing and settling transactions, standard data definitions may be different than standard data definition employed when the application is a consumer-based application. However, some standard data definitions (e.g., standard abbreviations, etc.) may be uniform regardless of the type of application to be evaluated.

The conformance engine 108 then compares the data definitions from the target application, to the standard data definitions. And, the conformance engine 108 generates a report for the application based on the comparison. This will be described in more detail hereinafter in connection with method 300.

FIG. 3 illustrates an exemplary embodiment of a method 300 for use in managing (or evaluating, etc.) data definitions of an application, for conformity with standard data definitions. The exemplary method 300 is described with reference to the system 100, and the computing device 200. The method 300, however, should not be understood to be limited to the system 100 and/or computing device 200, as other systems and computing devices may be employed to perform the method 300. Conversely, system 100 and computing device 200 should not be understood to be limited to the method 300.

As shown in FIG. 3, in the method 300, standard data definitions are initially set up, at 302 and stored, for example, in database 120 (which may be separate from the conformance engine 108, as shown in the system 100 of FIG. 1, or associated therewith, for example, in memory of a computing device associated with the conformance engine 108, etc.). In this embodiment, the conformance engine 108 creates containers for the particular data definitions, such as, for example, standard classes, standard abbreviations, etc. The conformance engine 108 then populates the containers with the standard data definitions associated with the containers. The containers are generally populated with content from previously approved data definitions (e.g., data definitions previously approved by one or more of the entities associated with the implementation part 104 of the system 100, etc.), etc. As an example, a standard abbreviations container may be populated, by the conformance engine 108, with abbreviations such as ASSOC, MOD, ID, etc. previously used and/or approved by the payment network 114 (e.g., in connection with previously implemented applications, etc.).

Separately, the conformance engine 108 identifies a target application (e.g., a pre-production application, etc.) at 302, from the development environment 106, to be evaluated. This may include receiving a request, from the development environment 106 (e.g., via a user developing an application in the development environment 106, etc.), to evaluate an application. Or, the conformance engine 108 may monitor the development environment 106, and evaluate some or all pre-production applications associated therewith (e.g., continuously, at predefined intervals, or according to one or more schedules, etc.).

In connection with identifying the target application from the development environment 106, the conformance engine 108 also determines what (if any) data definitions from the identified application are to be evaluated for conformity against the standard data definitions. This may be based on a last date of invocation for the conformance engine 108 for the application (e.g., as specified by the user developing the application, as calculated by the conformance engine 108 from logs, etc.), so that only new or revised data definitions in the application are evaluated. In one or more embodiments, the conformance engine 108 identifies all data definitions, included in the application, for example, to ensure or test whether prior violations of the standard data definitions have been resolved.

Next in the method 300, as shown in FIG. 3, the conformance engine 108 compares, at 306, the determined data definitions from the application to the standard data definitions included in the library database 120. As an example, when the data definitions include tables, the conformance engine 108 may compare a name of the table and/or a name included in a column (or elsewhere) in the table to a predefined standard name from the database 120 (e.g., a standard abbreviation or other name, etc.). In addition, the conformance engine 108 may also compare constraints associated with the table to standard rules from the database 120, such as a naming convention rule, a prefix rule, a suffix rule, etc.

Upon completion of the comparison at 306, the conformance engine 108 generates a report, at 308. The report identifies (e.g., flags, etc.) discrepancies between the data definitions in the identified application and the standard data definitions from the database 120. The report is delivered, by the conformance engine 108, to one or more users associated with the application (e.g., a developer assigned to the application, etc.).

As an example, when a data definition of the identified application includes a table and the table name has abbreviations that deviate from the corresponding data definitions, the conformance engine 108 identifies, in the report, each of the errant abbreviations. As another example, when a data definition of the identified application includes a table having multiple columns with various abbreviations included in each of the columns and when several of the abbreviations deviate from deviations of corresponding data definitions, the conformance engine 108 identifies, in the report, each of the errant abbreviations.

With further reference to FIG. 3, various different comparisons may be employed by the conformance engine 108, at 306, to evaluate the data definitions included in the application, and ensure that they conform to the library of standard data definitions in the database 120, or at least to parts thereof. Each of the various comparisons illustrated in FIG. 3 will be described in more detail below, with reference to multiple example data definitions (i.e., from a pre-production, target application), which in this example description include multiple different tables having a variety of different parameters. While the comparisons are described (and illustrated in FIG. 3) in a particular order, it should be appreciated that they may be performed in a different order within the scope of the present disclosure. It should also be appreciated that fewer and/or one or more different comparisons may be employed in other implementations.

As 310, the conformance engine 108 determines if the each of the different tables from the target application includes a primary key. In so doing, the conformance engine 108 identifies if a primary key is assigned to the table based on whether or not the table includes a constraint name having a “PK” suffix. If a primary key is not present in the table, the conformance engine 108 identifies the violation and generates a flag (which is included in the report generated at 308). In Table 1, an example report section identifies that one table, i.e., TEMP_TRGT table from the target application, does not include a primary key.

TABLE 1
Tables with missing Primary Key
TEMP_TRGT

The conformance engine 108 further compares names of each of the tables from the target application to standard abbreviations included in the library of standard data definitions (in database 120, for example), at 312. When the table names include parts which are inconsistent with the standard abbreviations, the conformance engine 108 identifies a violation, and indicates it by a flag in the generated report (at 308). Table 2 illustrates an example report section related to the comparison of the table names to the standard abbreviations. As shown in the table, the report indicates (or flags) that the terms, for example, TEMPLATE and DISPLAY (among others) are not standard abbreviations in the library, while the term ASSOC is a standard abbreviation in the library. Also in the table, in this example, the terms TYPE and USER are not identified (or flagged) as errant abbreviations, as these words are considered standard abbreviations in the library (i.e., the terms TYPE and USER are the standard abbreviations for TYPE and USER).

TABLE 2
Table Names - Naming Conventions Validation (Refer to std_abbr
table for standard abbreviations and std_appl_abbr
for application specific standard abbreviations)

| Table Name | Violation Details |
|---|---|
| OPTIONS_TEMPLATE | TEMPLATE is not a standard |
| | abbreviation. |
| OPTIONS_TEMPLATE | OPTIONS is not a standard |
| | abbreviation. |
| SETTING | SETTING is not a standard |
| | abbreviation. |
| SETTING_SCOPE | SETTING is not a standard |
| | abbreviation. |
| SETTING_SCOPE | SCOPE is not a standard abbreviation. |
| DISPLAY_GROUP | DISPLAY is not a standard |
| | abbreviation. |
| DISPLAY_GROUP | GROUP is not a standard abbreviation. |
| LDAP_USER_TYPE_ASSOC | LDAP is not a standard abbreviation. |

The conformance engine 108 also compares the column names of each of the tables from the target application to standard names and/or abbreviations included in the library of standard data definitions (in database 120, for example), at 314. The standard abbreviations may be the same, or different from, the standard abbreviations employed at 312. In this comparison, when the column names violate the standard names and/or abbreviations, the conformance engine 108 again generates a flag indicating the violation, and includes the flag in the report, as generated as 308. Table 3 illustrates an example report section having a number of exemplary flags for column name violations.

TABLE 3
Column Names - Naming Conventions Validation (Refer to std_abbr table for standard
abbreviations and std_appl_abbr for application specific standard abbreviations)

| Table Name | Column Name | Violation Details |
|---|---|---|
| MKT_SEG | CREATED_BY_USER_ID | CREATED is not a standard abbreviation. |
| MKT_SEG | LAST_UPD_USER_ID | UPD is not a standard abbreviation. |
| MKT_SEG | LAST_UPD_USER_ID | LAST is not a standard abbreviation. |
| MKT_SEG | LAST_MOD_DT_TM | LAST is not a standard abbreviation. |
| MKT_SEG | CREATED_DT_TM | CREATED is not a standard abbreviation. |
| MKT_SEG | IS_DEFAULT_SW | IS is not a standard abbreviation. |
| MKT_SEG | IS_DEFAULT_SW | DEFAULT is not a standard abbreviation. |
| MKT_SEG | DESCRIPTION | DESCRIPTION is not a standard |
| | | abbreviation. |
| MKT_SEG | RESOURCE_NAM | RESOURCE is not a standard |
| | | abbreviation. |
| OPTIONS_TEMPLATE | LAST_MOD_DT_TM | LAST is not a standard abbreviation. |
| OPTIONS_TEMPLATE | LAST_UPD_USER_ID | UPD is not a standard abbreviation. |
| OPTIONS_TEMPLATE | LAST_UPD_USER_ID | LAST is not a standard abbreviation. |
| OPTIONS_TEMPLATE | CREATED_DT_TM | CREATED is not a standard abbreviation. |
| OPTIONS_TEMPLATE | CREATED_BY_USER_ID | CREATED is not a standard abbreviation. |
| OPTIONS_TEMPLATE | IS_DEFAULT_SW | IS is not a standard abbreviation. |
| OPTIONS_TEMPLATE | IS_DEFAULT_SW | DEFAULT is not a standard abbreviation. |

After evaluating the column names, the conformance engine 108, in this example, compares class names of the columns of the tables from the target application to a listing of standard class names, at 316. As above, when the table includes a class name, which is not a standard class name, the conformance engine 108 generates a report, at 308, that includes a flag indicative of the violation. Table 4 illustrates an example report section, wherein the conformance engine 108 identified the use of the non-standard “DESCR” class name (among others), for example, as a violation.

TABLE 4
Columns with Class Names Violating Standards (Refer to std_class
table for standard list of class names)

| Table Name | Column Name | Violation Details |
|---|---|---|
| USER_TYPE_NAM | USER_TYPE_DESCR | DESCR is not |
| | | a class name |
| OPTIONS_TEMPLATE | DESCRIPTION | DESCRIPTION is |
| | | not a class name |
| OPTIONS_TEMPLATE | PROGRAM_NAME | NAME is not a |
| | | class name |
| MKT_SEG | DESCRIPTION | DESCRIPTION is |
| | | not a class name |

With continued reference to FIG. 3, the conformance engine 108 optionally checks names of primary keys of the tables from the target application, at 318, to confirm their conformance to a primary key naming convention. In particular, the conformance engine 108 determines, for each table, if the primary key includes the table name with the suffix “PK.” When the primary key is improper (e.g., does not include the suffix “PK”, etc.), the conformance engine 108 generates a flag indicating the violation, and includes the flag in the report generated at 308. Table 5 illustrates an example report section, where the conformance engine 108 determined that the primary key of the table “LDAP_USER_TYPE ASSOC” is improper in view of the standard criteria associated with the primary key naming convention. In addition to the flagged violation, the illustrated report section further includes the proper name of the primary key to aid the user (e.g., a developer for the target application, etc.) to identify and correct the violation.

TABLE 5
Primary Key Validation - Primary Key Constraint name should
be Table Name appended with_PK

| Table Name | Constraint Name | Violation Details |
|---|---|---|
| LDAP_USER_TYPE_ASSOC | USER_GROUP_NAM_PK | Constraint name should be |
| | | LDAP_USER_TYPE_ASSOC_PK. |

At 320, the conformance engine 108 also optionally checks names of foreign keys of the tables from the target application, at 318, to confirm their conformance to a foreign key naming convention. In particular, the conformance engine 108 determines, for each table, if the foreign key includes the table name with the suffix “FK.” When the foreign key is improper (e.g., does not include the suffix “FK”, etc.), the conformance engine 108 generates a flag indicating the violation, and includes the flag in the report generated at 308. Table 6 illustrates an example report section, where the conformance engine 108 determines that the foreign key for the table “SETTING” (among others), for example, is improper in view of the foreign key naming convention.

TABLE 6
Foreign Key Validation - Foreign Key Constraint name should be Table Name appended
with_FK followed by a sequence number for the foreign key for that table

| Table Name | Constraint Name | Violation Details |
|---|---|---|
| SETTING | DISPLAY_GROUP_SETTING_FK1 | Constraint name should be |
| | | SETTING_FK followed by a |
| | | sequence number. |
| DISPLAY_GROUP | DISPL_GRP_DISPL_GRP_FK1 | Constraint name should be |
| | | DISPLAY_GROUP_FK |
| | | followed by a sequence number. |
| OPTIONS_TEMPLATE | MKT_SEG_OPTIONS_TEMPLATE_FK1 | Constraint name should be |
| | | OPTIONS_TEMPLATE_FK |
| | | followed by a sequence number. |
| SETTING_SCOPE | MKT_SEG_SETTING_SCOPE_FK1 | Constraint name should be |
| | | SETTING_SCOPE_FK |
| | | followed by a sequence number. |

Likewise, at 322, the conformance engine 108 may further check names of alternate keys and/or unique keys of the tables from the target application, to confirm their conformance to a corresponding key naming convention (e.g., an alternate key naming convention identified by the suffix “AK”, etc.). As with the primary and foreign keys, the report generated by the conformance engine 108, at 308, includes flags for any violation of the particular key naming convention.

With still further reference to FIG. 3, the conformance engine 108 also compares the index names of each of the tables from the target application to a standard naming convention at 324. For example, a standard index name may include the table name and a suffix “IDX.” In this example, when the index names do not include the suffix “IDS”, the conformance engine 108 identifies a violation, and indicates it by a flag in the generated report (at 308). Table 7 illustrates an example report section in which the conformance engine identified various index names of tables inconsistent with the stand naming convention, and flagged them in the report section.

TABLE 7
Index Validation - Index name should be Table Name appended with _IDX followed by
a sequence number for the index for that table

| Table Name | Constraint Name | Violation Details |
|---|---|---|
| DISPLAY_GROUP | DISPLAY_GROUP_PK | Index name should be |
| | | DISPLAY_GROUP_IDX followed |
| | | by a sequence number. |
| MKT_SEG | MKT_SEG_1_UK | Index name should be |
| | | MKT_SEG_IDX followed by a |
| | | sequence number. |
| MKT_SEG | MKT_SEG_PK | Index name should be |
| | | MKT_SEG_IDX followed by a |
| | | sequence number. |
| OPTIONS_TEMPLATE | OPTIONS_TEMPLATE_PK | Index name should be |
| | | OPTIONS_TEMPLATE_IDX |
| | | followed by a sequence number. |

In addition to the naming parameters of the tables (broadly, the data definitions) from the target application, as described above, the conformance engine 108 also checks (or determines), in some aspects of the method 300, if appropriate constraints exist in the tables (e.g., whether or not particular columns or cells of the table are properly constrained when a switch is indicated, etc.). Here, the conformance engine 108 does not, so much, review content of the tables, but instead reviews restrictions (or constraints) on the tables, for example, on columns of the tables defined as switches. When the conformance engine 108 identifies that a constraint, for example, for a column of a table with restricted “Y” or “N” values, is missing, the conformance engine 108 flags the table/column as a violation (because, when a development team imposes the constraint on the switch column, if the data contains other values outside of the “Y” or “N” values, the constraint cannot be defined). In the example report section of Table 8, the conformance engine 108 identified an errant constraint associated with a column.

TABLE 8
Check Constraint Validation - Columns which are defined as switches
should a check constraint (valid values Y/N)

| Table Name | Column Name | Details |
|---|---|---|
| SETTING_SCOPE | IS_VISIBLE_SW | Define a check constraint |
| | | on the column |
| | | IS_VISIBLE_SW |

Still further, in some aspects of the method 300, the conformance engine 108 compares various additional parameters of the tables from the target application. For example, as illustrated in the example report section of Table 9, the conformance engine 108 may check columns of the tables in a primary key with a number datatype, but without a sequence number or with a different naming convention. Violations are then identified by the conformance engine 108 in the report section (see Table 9), when generating the report at 308.

TABLE 9
Sequence Validation - Checking is done on the columns that are the only columns in a
primary key with a NUMBER datatype without a sequence number or with a different
naming convention. Sequence Names should be the column name appended with
_SEQ. These columns are just an indication if a sequence number needs
to be created on the specified column.

| Table Name | Column Name | Details |
|---|---|---|
| DISPLAY_GROUP | DISPLAY_GROUP_ID | Either the column |
| | | DISPLAY_GROUP_ID does not |
| | | have a sequence or it does not have a |
| | | sequence with the expected name - |
| | | DISPLAY_GROUP_ID_SEQ |
| MKT_SEG | MKT_SEG_ID | Either the column MKT_SEG_ID |
| | | does not have a sequence or it does |
| | | not have a sequence with the |
| | | expected name - |
| | | MKT_SEG_ID_SEQ |
| OPTIONS_TEMPLATE | OPTIONS_TEMPLATE_ID | Either the column |
| | | OPTIONS_TEMPLATE_ID does not |
| | | have a sequence or it does not have a |
| | | sequence with the expected name - |
| | | OPTIONS_TEMPLATE_ID_SEQ |
| SETTING | SETTING_ID | Either the column SETTING_ID does |
| | | not have a sequence or it does not |
| | | have a sequence with the expected |
| | | name - SETTING_ID_SEQ |
| SETTING_SCOPE | SETTING_SCOPE_ID | Either the column |
| | | SETTING_SCOPE_ID does not have |
| | | a sequence or it does not have a |
| | | sequence with the expected name - |
| | | SETTING_SCOPE_ID_SEQ |

It should be appreciated that a variety of different comparisons may be made, by the conformance engine 108, in other embodiments, to ensure that data definitions from applications are consistent with one or more standard data definitions. Different parameters of the data definitions may be compared to different standard data definition criteria, for example, in different orders. For example, certain parameters of data definitions may be compared, during evaluations by the conformance engine 108 at one time, with the same or different parameters of the data definitions being evaluated at a different time. In addition, it should be appreciated that, in multiple embodiments, the type and extent of the parameters of the data definitions evaluated may be based on the type of applications, the type of data generated by the applications, and/or the expected use of the data from the applications. For example, when data from an application drives financial transaction, such as in FIG. 1, numerous different parameters of the data definitions from the application may be evaluated, at regular intervals during development. Other applications may be evaluated less often, and less specifically, when the data from the applications is used for non-financial purposes, for example. Again, the frequency and/or level of evaluation is selected, by the user (e.g., the developer, etc.) or others as may be appropriate for a particular application.

Further, as indicated above, the conformance engine 108 may limit the data definitions evaluated based on a temporal constraint imposed by the user (e.g., the developer associated with the application, etc.), or automatically. For example, a temporal constraint may limit the evaluation to just data definitions, which were created or revised, since a last invocation of the conformance engine 108. When the application is evaluated for revisions after a particular date, for example, the generated report may include an entry, which reflects the data from which the revisions are included the test, such as shown in Table 10.

TABLE 10
The violation details report is created for only those columns/tables
created after 12-JAN-YYYY (as specified in validate_standards.bat)

In this manner, the data definitions in one or more applications are evaluated during the pre-production, i.e., the development stage, of the applications. In so doing, violations of standard data definitions are identified and reported to one or more users (e.g., developers of the applications, etc.), whereby the users may readily change the non-standard data definitions, as desired, to conform to one or more standard data definitions. When the applications, after being subjected to the systems and methods herein, are delivered, i.e., post-production, it is substantially likely that the data definitions associated therewith will conform with standard data definitions.

In some exemplary embodiments, a software development system is provided (e.g., via one or more computing device, etc.) configured to support one or more of the operation described in connection with method 300. For example, in one exemplary embodiment, such a system is configured to (e.g., via one or more processors, etc.), among other operations, identify at least one data definition defined in a pre-production application, compare the at least one data definition to standard data definition criteria, and generate a report for the pre-production application based on the comparison where the report includes at least one flag when at least one discrepancy exists between the data definition in the pre-production application and the standard data definition criteria.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations alone, or in combination in any desired order: (a) identifying an application to be tested where the application includes a pre-production code-segment and at least one data definition; (b) comparing the at least one data definition of the application to standard data definitions in a library of standard data definitions; (c) generating a report where the report includes a flag when at least one discrepancy is identified by the computing device between the at least one data definition in the application and the standard data definitions; (d) selecting a subset of multiple data definitions based on a temporal criteria; and (e) confirming a restriction of a data type.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements, and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer readable storage media including executable instructions, which when executed by at least on processor, cause the at least one processor to:
identify a pre-production application, the pre-production application including at least one data definition;
access a library of standard data definitions applicable to said pre-production application, the library of standard data definitions including multiple standard data definition criteria;
identify the at least one data definition from the pre-production application;
compare the at least one data definition to at least one of the multiple standard data definition criteria corresponding to said at least one data definition; and
generate a report for the pre-production application based on the comparison, the report including at least one flag when at least one discrepancy exists between the at least one data definition in the pre-production application and the at least one of the multiple standard data definition criteria.

2. The computer readable storage media of claim 1, wherein when executed by the at least one processor, the executable instructions cause the at least one processor to, in order to compare the at least one data definition to the standard data definition criteria:
compare a constraint name of the at least one data definition to a name of the standard data definition criteria; and
identify a violation when the constraint name fails to include the standard data definition criteria name; and
wherein the at least one flag is indicative of said violation.

3. The computer readable storage media of claim 1, wherein the standard data definition criteria includes standard abbreviations and/or standard names.

4. The computer readable storage media of claim 3, wherein the at least one data definition includes multiple names;
wherein, when executed by the at least one processor, the executable instructions further cause the at least one processor to, in order to compare the at least one data definition to the standard data definition criteria:
compare the multiple names to the standard abbreviations and/or standard names of the standard data definition criteria; and
identify a violation when at least one of the multiple names is inconsistent with the standard abbreviations and/or standard names; and
wherein the at least one flag is associated with the violation; and wherein the report includes the at least one of the multiple names associated with the violation.

5. The computer readable storage media of claim 1, wherein the at least one data definition includes multiple constraints; and
wherein, when executed by the at least one processor, the executable instructions further cause the at least one processor to, in order to compare the at least one data definition to the standard data definition criteria:
test each of the multiple constraints of the at least one data definition against one or more rules; and
identify a violation of said one or more rules; and
wherein said at least one flag is associated with the violation.

6. The computer readable storage media of claim 5, wherein the one or more rules include at least one of a standard suffix and a standard prefix for a constraint name associated with each of the multiple constraints.

7. The computer readable storage media of claim 1, wherein, when executed by the at least one processor, the executable instructions further cause the at least one processor to:
create a standards data structure; and
populate the standards data structure with the standard data definition criteria.

8. A computer-implemented method for use in evaluating database compliance, the method comprising:
identifying an application to be tested, the application including a pre-production code-segment and at least one data definition;
comparing, at a computing device, the at least one data definition of the application to standard data definitions in a library of standard data definitions; and
generating, at the computing device, a report, the report including a flag when at least one discrepancy is identified by the computing device between the at least one data definition in the application and the standard data definitions.

9. The computer-implemented method of claim 8, wherein the at least one data definition includes a table.

10. The computer-implemented method of claim 9, wherein the table includes a table name; and
wherein comparing the at least one data definition includes comparing the table name to standard abbreviations included in the library of standard data definitions.

11. The computer-implemented method of claim 9, wherein the table defines at least one column having a column name; and
wherein comparing the at least one data definition includes comparing the column name to standard abbreviations included in the library of standard data definitions.

12. The computer-implemented method of claim 9, wherein the table defines at least one column having a class name; and
wherein comparing the at least one data definition includes comparing the class name to standard class names included in the library of standard data definitions.

13. The computer-implemented method of claim 9, wherein the table includes at least one constraint; and
wherein comparing the at least one data definition includes testing the at least one constraint of the table against one or more rules.

14. The computer-implement method of claim 13, wherein the one or more rules includes at least one of:
a naming convention relative to a table name of the table,
a prefix of a constraint name associated with the at least one constraint of the table, and
a suffix of a constraint name associated with the at least one constraint of the table.

15. The computer-implemented method of claim 8, wherein the identified application defines multiple data definitions;
wherein said method further comprises selecting, by the computing device, a subset of the multiple data definitions based on a temporal criteria; and
wherein comparing the at least one data definition to the standard data definitions includes comparing only the subset of the multiple data definitions to the standard data definitions.

16. The computer-implemented method of claim 8, wherein the at least one data definition includes a data type;
wherein said method further comprises confirming, by the computing device, a restriction of the data type; and
wherein the flag indicates the restriction is absent, when the data type is absent.

17. A system for use in managing data definitions within payment applications, the system comprising:
a memory comprising a plurality of standard data definitions; and
at least one processor coupled to the memory and configured to:
identify a payment application to be evaluated, the payment application including a pre-production code-segment and at least one data definition;
access the standard data definitions in the memory applicable to the payment application;
identify the at least one data definition from the payment application;
compare the at least one data definition from the payment application to the standard data definitions in the memory; and
generate a report for the payment application when, based on the comparison, at least one discrepancy exists between the at least one data definition in the payment application and the standard data definitions, the report identifying the at least one discrepancy.

18. The system of claim 17, further comprising a development environment in which the payment application is developed; and
wherein the at least one processor is configured to:
identify the payment application from the development environment; and
transmit the report generated for the payment application to the development environment.

19. The system of claim 18, further comprising a payment network configured to implement the payment application.

20. The system of claim 17, wherein the at least one data definition of the payment application includes a table.
